(19) United States
(12) Patent Application Publication
(10) Pub. No.: US 2026/0111911 A1
(43) Pub. Date: Apr. 23, 2026

(54) QUALIFYING A SERVICE

(71) Applicant: HEWLETT PACKARD ENTERPRISE DEVELOPMENT LP, Spriong, TX (US)

(72) Inventors: PETER MICHAEL BRUUN, Rungsted Kyst (DK); JANE KOENIGSFELDT, Alleroed (DK); ULRIK STUHR LARSEN, Alleroed (DK)

(21) Appl. No.: 18/921,780

(22) Filed: Oct. 21, 2024

(51) Int. Cl. G06Q 30/015

(52) U.S. Cl. CPC G06Q 30/015

(57) ABSTRACT

1. Systems and methods are provided for performing service qualification. A system for performing service qualification includes one or more processors and memory comprising instructions that, when executed, cause the one or more processors to receive, via a user interface of a computing device, a service qualification request, provide, to a provisioning model configured to provision a service for a customer, a service introspection request based on the service qualification request, receive, from the provisioning model, one or more instance results indicating whether the service can be provided to the customer, and generate and output, based on the one or more instance results, a qualification result indicating at least one of whether and when the service can be provided to the customer.

### BACKGROUND

Service providers (such as telecommunications service providers) of one or more types of services perform provisioning to allocate and configure resources for services to be provided to a customer (e.g., a customer facing service, or CFS) and to activate the services. Service qualification may be performed prior to provisioning to determine whether various services can be provided to the customer in response to a service request. Service qualification is the process of finding and checking whether and when (e.g., a specific timeframe, time and/or date, etc.) requested services can be provided to the customer. In various examples, service qualification can be performed by, for example a sales representative, a call-center, a partner company, or by the user (e.g., via a self-service portal).

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates one example configuration of a system configured to implement service qualification systems and methods according to the principles of the present disclosure.

FIG. 2 illustrates an example system including a request generator and a service controller configured to implement service qualification techniques according to the principles of the present disclosure.

FIGS. 3A and 3B illustrate steps of an example method for qualifying a service in accordance with the principles of the present disclosure

FIG. 4 illustrates a computing device or platform that may be used to perform service qualification according to the principles of the present disclosure.

FIG. 5 depicts a block diagram of an example computer system in which various examples of the disclosed technology described herein may be implemented.

The figures are not exhaustive and do not limit the present disclosure to the precise form disclosed.

### DETAILED DESCRIPTION

In some examples, service order management and service provisioning automation systems implement a process (e.g. workflow) or model to perform service qualification. Service qualification may be performed in accordance with various application programming interface (API), standards, such as TMForum standard TMF645. However, existing service qualification solutions implement service qualification processes independently of a service orchestration component of the provisioning process. Service orchestration refers to rule-driven and automated configuration, management, and coordination of computing systems and devices, resources, services, software, and so on. Such orchestration may involve coordinating tasks and/or processes across multiple systems. Accordingly, coordinating between service qualification and provisioning processes is difficult and achieving consistency between these processes can be costly, time-consuming, and susceptible to errors.

Further, provisioning systems evolve over time. For example, services that the service provider offers to customers evolve (e.g., new services are created, new options are provided to meet changing market demands and remain competitive, etc.). Technology also evolves, so options that were not previously available or feasible may become available at a later time. Further, physical implementation of access technology changes (e.g., fiber-optical cables are deployed, wireless infrastructure advances from 4G to 5G, etc.) and partnerships between entities change, along with delegations to partner companies and corresponding capabilities. Accordingly, an independently developed qualification system, even if initially correct, will not remain correct indefinitely.

Service qualification systems and methods according to the present disclosure are configured to achieve consistency between service qualification and provisioning by using a provisioning model (i.e., the same model used to provision a service subsequent to service qualification) to perform service qualification, which may be referred to as “provisioning model introspection.”

As used herein, a “service specification” (e.g., a service specification according to a TMForum standard) describes the attributes and characteristics of a type of service that customers may request. The service specification is part of a service catalog that customers can browse to select the types of services they want. The service specification alone may not have sufficient information to provision the service, which requires decomposing the request into resources, assigning values, and executing commands.

As used herein, “provisioning model introspection” refers to using, evaluating, or interpreting the provisioning model to perform service qualification. As used herein, “interpreting” the provisioning model may include, inter alia, evaluating the provisioning model by providing various inputs and obtaining corresponding outputs. In other words, inputs corresponding to a service qualification request are interpreted using the provisioning model and the outputs of that interpretation therefore correspond to the same outputs that the provisioning system would use to provision the service. The qualification results are then calculated based in part on these outputs of the evaluation of the provisioning model.

As used herein in the context of the provisioning model, the term “model” refers to declarative provisioning model defining properties and interdependencies of a service and constituent components and resources of the service. As a declarative model, the provisioning model may not explicitly specify the order of actions to provision and activate the service (e.g., in contrast to a procedural provisioning system). Instead, the provisioning model can be interpreted by a provisioning system to derive procedural flows required to provision and activate the service.

As used herein, the term “service descriptor” refers to a component of a provisioning model, declaratively describing how to compute the properties that an instance of the component would have, and how to relate that component to other components, making up a fully provisioned service instance. Such a descriptor may correspond to a node in topology and orchestration specification for cloud applications (TOSCA) terminology.

Service qualification systems and methods according to the present disclosure are further configured to provide a qualification result by first retrieving a set of possible qualification results (“options”) and subsequently narrowing these results by filtering the options based on additional constraints. Accordingly, rather than performing complex computational tasks involving many technical and other constraints, the qualification results are narrowed in a sequential manner to simplify the service qualification process.

Accordingly, systems and methods according to the present disclosure, as described below in more detail, create accurate qualification solutions in a timely manner and at reduced cost. Further, the accuracy of the qualification solutions obtained using these systems and methods is maintained over time while minimizing effort and risk since any changes in the provisioning model are automatically detected and accounted for via the described introspection mechanisms.

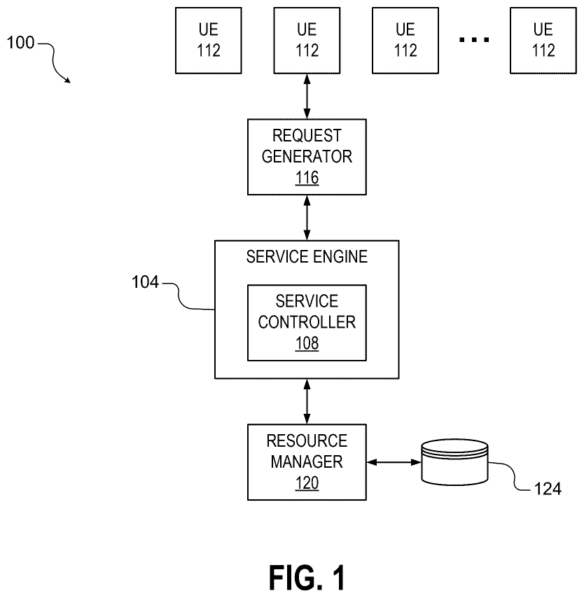

FIG. 1 shows an example system 100 configured to implement service qualification systems and methods according to the principles of the present disclosure. The system 100 may be configured to perform both service qualification and service provisioning subsequent to service qualification. The system may correspond to a telecommunications, digital, or other type of network or service provider configured to provide a plurality of types of (e.g., potentially interrelated and interdependent) services to customers (e.g., cellular services, internet services, cable television services, etc.).

The system 100 includes a service engine 104 configured to (e.g., at a service controller 108) receive service qualification requests, perform service qualification, receive commands to provision services, and perform provisioning of services. As used herein in various contexts, “requests” may generally refer to both service qualification requests and provisioning requests or commands. The service engine 104 may be further configured to instruct the assignment of physical resources (e.g. server or other computing devices) to implement various network functions.

The service engine 104 and the service controller 108 may be implemented by one or more computing devices using dedicated hardware, e.g. circuitry, or a combination of software and hardware, such as computer program code or computer-readable instructions stored in a non-transitory computer-readable storage medium that is available to be processed by one or more central processing units of the server computer devices. The service engine 104 may be embodied in a single computing device or may form a distributed system over a plurality computing devices.

The service engine 104 may receive requests corresponding to requests from one or more users, shown in FIG. 1 as client or user equipment (UE) devices 112. Examples of UE devices may include, but are not limited to: desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IoT) devices, and the like. Users of the UE devices 112 may be service users, e.g., users tasked with requesting a service (e.g., a sales representative, a call-center, a partner company) or end users/customers (e.g., via a self-service portal executed on/by user interfaces of the UE devices 112).

The requests may be received and transmitted to the service engine 104 by a request generator 116 communicatively coupled to the UE devices 112 and the service engine 104. The request generator 116 is configured to generate requests in response to inputs from the UE device 112. For example, the request generator 116 may include and/or implement a resource management system configured to manage network elements of a telecommunications service provider, digital service provider, hybrid service provider, etc. The request generator 116 may include or be accessed by users via an operations support system (e.g., a system used by telecommunications providers to manage telecommunications networks). The system 10 may include more than one request generator 116.

As one example, the UE devices 112 may implement a graphical user interface configured to provide a graphical front end for users to input requests or commands, such as by completing a form including interface elements associated with parameters defined in a service specification. The request generator 116 is configured to generate, in response to the inputs provided by the users, requests to perform service qualification, provisioning, and so on.

In some example, embodiments, the system 100 may include a resource manager 120 communicatively coupled to the service engine 104 and a resource data store 124. The resource data store 124 stores records of a set of physical, logical and/or virtual resources that are available to implement a service and associated entities. For example, the resource data store 124 may include a record of components that make up a physical and/or virtual infrastructure. While logical and virtual resources are provided as examples, it is to be understood that these resource may ultimately be implemented using hardware resources such as physical computing, storage, and or network resources. For example, a network function virtualization infrastructure may comprise virtual computing (e.g. processor), virtual storage (e.g. hard disk), and virtual network (e.g. virtual network interface controllers) resources implemented on a virtualization layer (e.g. implemented by one or more hypervisors or virtual machine monitors). The virtualization layer then operates on hardware resources such as processor devices, storage devices, and physical network devices, for example as provided by one or more server computing devices. The resource manager 120, together with the resources defined in the resource data store 124, provide entity-action building blocks based on a physical and/or virtual infrastructure that may be combined in the form of a descriptor to enable the provisioning of a service.

The service engine 104, the service controller 108, and the request generator 116 are configured to perform service qualification according to the present disclosure. For example, the request generator 116 is configured to generate and provide a service request (e.g., service qualification requests, queries or introspections, etc.) to the service engine 104. The service engine 104 may implement all or portions of a provisioning model configured to provision services, including any services associated with the service qualification request. The service engine 104 provides one or more service specifications corresponding to the service introspection request to the provisioning model. For example, the provisioning model is configured to communicate with the resource manager 120, the resource data store 124, and/or other components or entities to determine whether the service specifications can be met by the system 100 to provision the request. The request generator 116 generates a qualification result based on the determination made by the provisioning model as described below in more detail. As used herein, the term “service descriptor” may include and/or refer to various types of information used to provision and/or qualify a requested service, such as service specifications, service parameters and/or entities, declarative model-oriented descriptors (e.g., dynamic service descriptors, topology and orchestration specification for cloud applications (TOSCA) descriptors, etc.), and so on.

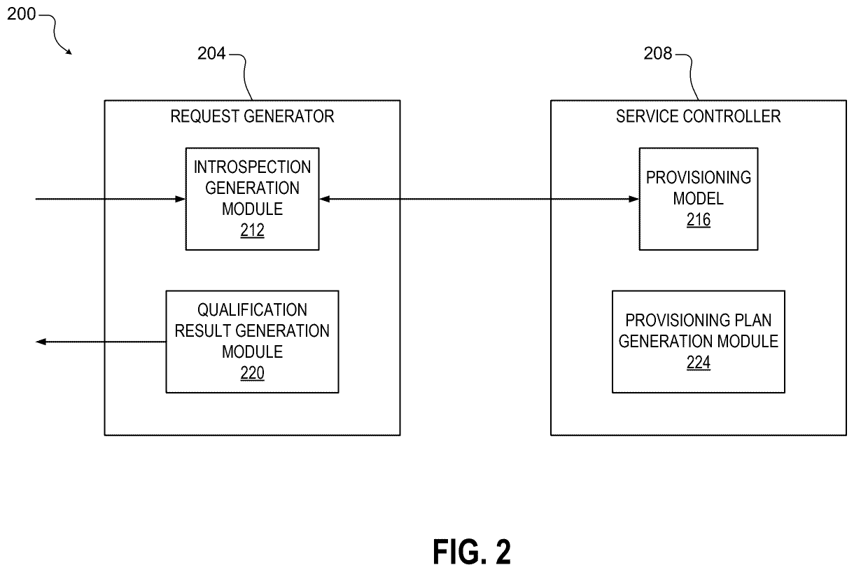

FIG. 2 illustrates one example system 200 (e.g., an orchestration system) that could implement one or more functions of the systems and methods of the present disclosure. In this example, the system 200 includes a request generator 204 and a service controller 208 (e.g., corresponding to the request generator 116 and the service controller 108, respectively, of FIG. 1) configured to implement service qualification techniques according to the principles of the present disclosure. The request generator 204 and the service controller 208 may be implemented by or on same or separate computing devices, processors, servers, etc.

The request generator 204 is configured to receive service qualification requests and introspections (e.g., in response to inputs from the UE devices 112). In some contexts, user inputs at the UE devices 112, data transmitted from the UE devices 112 in response to the user inputs, and/or data generated by the request generator 204 may each be generally referred to as “service qualification requests.” In some examples, one or more of the UE devices 112 are configured to implement all or portions of an API and the inputs are received by the API. In contrast, the service controller 208 may receive service requests.

For example, the request generator 204 receives, from the UE devices 112, inputs used to perform query service qualification (e.g., a qualification query request) and/or check service qualification (e.g., a qualification check request), which may be referred to as a service qualification query and a service check, respectively. A service qualification query creates and manages a list of available customer facing services satisfying some search criteria (e.g., location, customer profile, service characteristics, etc.). The result of a service qualification query is a list of potential services that meet the search criteria (e.g., a list of some category of service specifications available at a given place, a list of service specifications connectable to an existing service, etc.) and parameter ranges for the services. Typically, a response to a service qualification query is received relatively quickly (e.g., within seconds).

Conversely, a service check includes a performing a detailed feasibility check for a list of service options (e.g., to determine eligibility of a specific service configuration for a given context), which may include interactions with external and/or partner systems/entities. For example, a service check may determine whether and when 4K television service can be provided at a specific address, determine whether and when new IP television service can be provided at the same location of an existing active service, determine whether and when an existing, active service can be upgraded from 100 Mb/s to 600 Mb/s, etc. The result of a service check may indicate whether the request is eligible or ineligible, along with an indication of why the request is ineligible or when it would become available and, in some examples, alternate options for the service.

Example user inputs from the user (e.g., as received via one or more of the UE device 112) may include, but are not limited to: customer information; service requirements (e.g., desired service, service level, features, etc.); location information; and order preferences (e.g., a date for the service to be provided by). As one example, an input to the request generator may indicate a request for a particular service type (e.g., mobile, internet, television, etc.) at a particular location, desired features (e.g., 4G, 5G, HDTV, 4KTV, etc.), and desired value ranges (e.g., bandwidth, quality-of-service, etc.).

Information derived from these inputs is used as inputs for the service qualification query and service check. Example information used for the service qualification query and service check may include, but are not limited to, inputs indicating (e.g., using names or labels as used in the TMForum standard, for example only): one or more of a Service or Service Instance (a CFS, such as internet service for the customer, or a Resource Facing Service), ServiceSpecification (a specification of a type or class of services a customer has, technical attributes, resource requirements, etc.), Category (e.g., broadband, mobile, television, etc.), and ServiceCharacteristics (service type, bandwidth, etc.); RelatedParty (any entities affiliated with the customer); place or location (e.g., where the customer wants the service); and an expected qualification date.

In an example, the request generator 204 includes an introspection generation module 212 configured to receive the user inputs corresponding to a service qualification request, determine one or more service specifications associated with the service qualification request, and for each service specification generate a service introspection request. The service introspection request is provided to a provisioning model 216 of the service controller 208. Although shown within the service controller 208, all or portions of the provisioning model 216 may be located and/or executed external to the service controller 208. In other words, although shown schematically within the service controller 208, the provisioning model 216 corresponds to data stored within the service controller 208, in an external database, etc., and retrieved and executed, interpreted, and/or otherwise evaluated by the service controller 208. As one example, the service controller 208 may include and/or be configured to function as an interpreter or evaluator of the provisioning model 216.

The interpreter of the provisioning model 216 according to the present disclosure is further configured to receive introspection requests, and responses/outputs resulting from the introspection requests correspond to a first or initial list of qualification results. Each introspection request may include an indication of a service specification associated with service qualification requests (queries and/or checks) from the request generator 204.

In response to each introspection request, the provisioning model interpreter 216 is designed to perform functions associated with a CFS request and provide, to the request generator 204, a validated instance result. For example, the provisioning model 216 calculates service instance details and decomposition based on parameters of the introspection request, the service specifications for services requested by the customer, a service model, etc. Accordingly, the validated instance result indicates whether the requested service can be provided in accordance with requested parameters and may include default values associated with the parameters, value range options for the parameters, and so on. An initial validated instance result corresponds to one of the initial list of validated instance results. Together, the results in the initial list of validated instance results are a set of possible qualification results (e.g., whether a broad service category, such as a new line, can be provided and at what parameters).

In some examples, the request generator 204 includes a qualification result generation module 220 configured to perform functions related to narrowing the initial validated instance to generate a narrowed, final qualification result. For example, the qualification result generation module 220 generates and narrows qualification results in accordance with additional policy and validity checks, and to reduce lists of options for each characteristic property of the service. The qualification results can be immediately (e.g., within seconds or minutes) provided to the customer/user (e.g., via the UE devices 112) and/or persisted in accordance with API standards.

In some examples, the service controller 208 (e.g., using a provisioning plan generation module 224) may be configured to generate a provisioning plan for the service in response to each introspection request and provide provisioning result information to the request generator 204 based on the provisioning plan. For example, generating and executing a dry run of a provisioning plan may facilitate a determination of whether the requested service can be provisioned. In this manner, the narrowing performed by the request generator 204 may be informed by the provisioning result information.

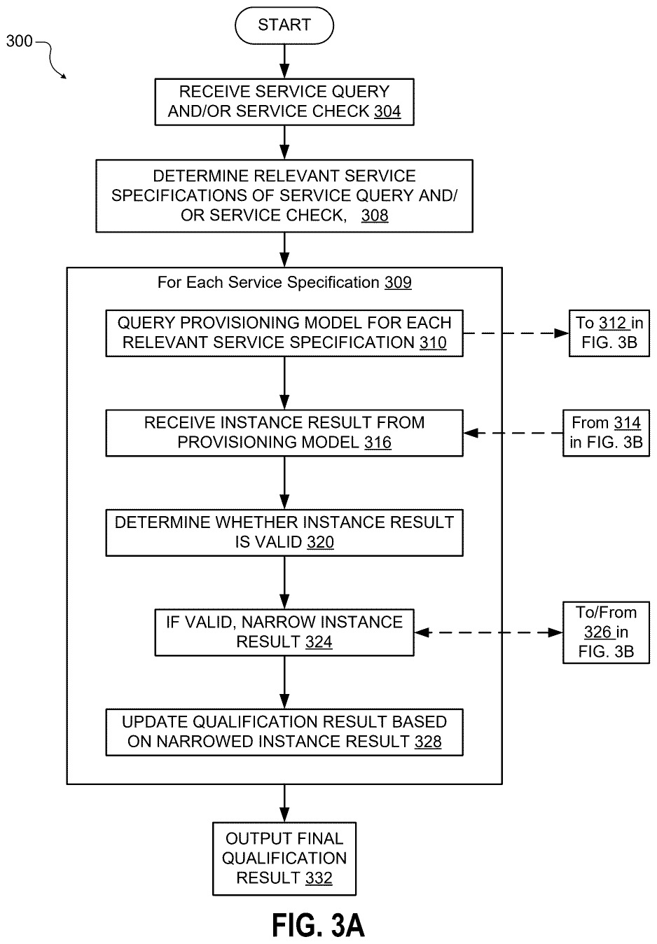

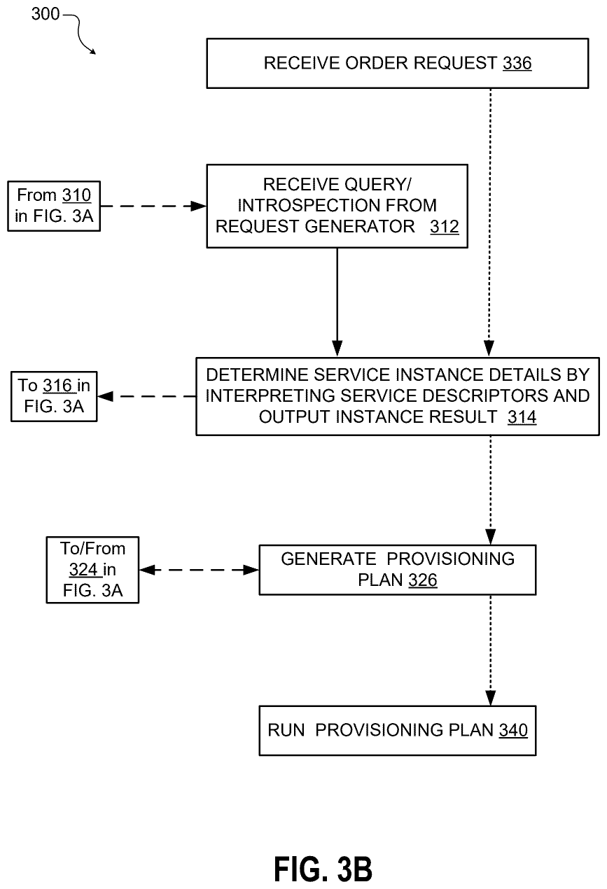

FIGS. 3A and 3B illustrate steps of an example method 300 for qualifying a service in accordance with the principles of the present disclosure. For example, one or more computing devices, processors, or processing devices, etc. are configured to execute instructions to implement the method 300, such as one or more of the processors of the systems described herein (e.g., a computing device or processor of a system configured to implement the request generator 204, the service controller 208, etc.). One or more of the steps of the method 300 as described below may be skipped or omitted in some examples, the steps may be performed sequentially or non-sequentially, synchronously or asynchronously, concurrently or non-currently, etc. Portions of the method 300 corresponding to functions of the request generator 204 are shown in FIG. 3A. Conversely, portions of the method 300 corresponding to the functions of the service controller 208 are shown in FIG. 3B.

As shown in FIG. 3A, at 304 the method 300 includes receiving a service qualification request (e.g., at a request generator, via a UE device, etc.). The service qualification request may include information corresponding to a service qualification query and/or service qualification check. For example, receiving the service qualification request may include receiving inputs from a customer or other user corresponding to a request to perform the service qualification query and/or service qualification check. A service qualification query creates and manages a list of available customer facing service options satisfying some search criteria and provides a list of potential service orders that meet the search criteria. Conversely, a service check includes a performing a detailed feasibility check for a list of service options and indicates whether the request is eligible or ineligible, along with an indication of why the request is ineligible and, in some examples, alternate options for the service.

At 308, the method 300 includes determining relevant service specifications, of the service qualification query and/or service check. For example, the service qualification request may be simple (e.g., can 4K television service be provided at a specified address?) or complex (e.g., can 4K television service be provided at a specified address and can a download speed of an existing service at the specified address be upgraded from 100 Mb/s to 600 Mb/s?). Accordingly, the determined service specifications may include a first specification, a second service specification, etc. In some situations, no (zero) service specifications may be determined/found. In some examples, determining the service specifications may include retrieving relevant external information from external databases (e.g., location, partners, etc.), service catalogs (e.g., as defined by TMF633 or another standard), etc.

In a process defined within block 309, the method 300 includes querying (e.g., providing an introspection request to) a provisioning model for each service specification (e.g., to initiate provisioning model introspection). In other words, the steps within 309 may be performed for each service specification determined at 308. At 310, the method 300 includes querying the provisioning model as shown at 312 in FIG. 3B. For example, querying the provisioning model includes generating a service introspection request or query based on each service specification and providing the service qualification request to the provisioning model (e.g., to the provisioning model 216 of the service controller 208). Querying the provisioning model may include providing a service qualification request corresponding to the service specification.

At 316, the method 300 includes receiving an instance result from the provisioning model (as generated at 314 in FIG. 3B), such as from an interpreter or evaluator of the provisioning model. For example, an interpreter of the provisioning model is configured to determine one or more service descriptors based on the service specification provided at 310 and generates the instance result by interpreting these service descriptors. The instance result indicates whether the requested service can be provided in accordance with requested parameters (as indicated by the service specification) and may include default values associated with the parameters, value range options for the parameters, and so on. The instance result received at 316 corresponds to a validated instance result or set of possible qualification results (e.g., whether a broad service category, such as 4K television service, a new line, etc., can be provided and at what parameters) for the service specification provided at 310.

At 320, the method 300 includes determining whether the instance result received from the provisioning model is valid (i.e., whether the provisioning model is able to create a service instance for the service specification under the given qualification requirements and other constraints defined by the rules of the provisioning model). For example, if the service specifications indicated a request for 4K television service at a particular location, the instance result may broadly indicate whether or not a provisioning system is able to create/provide a corresponding service (e.g., 4K television service) with the given service specification. Accordingly, at 320, the method 300 may simply determine that, yes, the service can be provided (and proceed to 324) or, no, the service cannot be provided. If the instance result is determined to be valid at 320, the method 300 proceeds to 324.

At 324, if the instance result is determined to be valid at 320, the method 300 includes narrowing the initial, list of instance results in accordance with more specific parameters/details associated with the service qualification request to obtain a narrowed instance result. Narrowing the instance result may include performing additional queries, investigations, or calculations, adding additional constraints associated with the service qualification request (e.g., narrowed value ranges), querying external and/or partner systems, entities, or databases, prompting the service provisioning model to generate and execute a dry run of a provisioning plan (e.g., as shown at 326 in FIG. 3B), etc. Techniques used to narrow the instance result may include, but are not limited to:
evaluating validation policies specified in the provisioning model;
generating and executing a dry run of a provisioning plan (e.g., using the provisioning model to generate a provisioning plan, simulate provisioning steps, and determine dependencies between specifications);
executing qualification functions or workflows defined in the provisioning model (which may include communicating with external rules databases, inference and optimization engines, artificial intelligence-based systems, etc.); and/or
specializing a qualification in accordance with a specific type or category of service (e.g., specializing a qualification for internet service to differentiate from television service).

At 328, the method 300 includes updating a qualification result based on the narrowed instance result. For example, an initial qualification result may be generated in response to determining that the instance result is valid (e.g., at 320), or an instance result may be removed from the result list if the instant result is invalid. As an example, the initial qualification result may simply indicate that 4K television service is available at a specified location while the updated qualification result may indicate that 4K television service is available at the specified location and by a specified date, at a specified bandwidth, for a specified quantity of devices, etc. Accordingly, the updated qualification result indicates whether the service specifications can be met at the specified service parameters.

Subsequent to updating the qualification result at 328, the method 300 repeats steps 310 through 328 for any additional service specifications to validate. As described above, in a first iteration of step 310 only a first service specification may be provided to the provisioning model. However, the service qualification request may include multiple service specifications for different service categories, locations, and so on (e.g., 4K television service, internet service, a new line, an upgrade to an existing line, etc.). Accordingly, if the method 300 determines that there are additional service specifications to validate, the method 300 proceeds to 310 to perform introspection for the additional service specifications. If those additional service specifications are found to be valid they are also added to the result at 328. If the method 300 determines that there are no additional service specifications to validate, the method 300 proceeds to 332.

At 332, the method 300 includes outputting a final qualification result. The final qualification result indicates validation results for the service specifications that were determined to be valid in steps 310 through 328. Accordingly, in some examples (e.g., service checks) the final qualification may include indications that one or more service requirements may be met (e.g., a requested service can be provided with the requested parameters, at the requested location, by the requested date, etc.) and/or that one or more service requirements cannot be met. In other examples (e.g. service queries), the final qualification may simply omit results corresponding to service requirements that cannot be met. As described herein, the final qualification result may indicate that no (zero) service specifications may be determined/found. Accordingly, the indications that one or more service requirements may be met may including an indication that no service requirements are met.

The final qualification result may be provided to the user. For example, the final qualification result is transmitted to a UE device for display on a user interface. In some examples, the final qualification result may be used to submit a CFS order (e.g., in response to a user providing an input indicating that proceeding with provisioning of the service is desired, such as at a UE device). The CFS order may include all or only some of the services contained in the service qualification result. In an example, the CFS order is provided to the provisioning model to proceed with provisioning of the service as described below in more detail.

As shown in FIG. 3B, the method 300 includes, at 312, receiving a query, such as a service introspection request (e.g., from a request generator) resulting from 310 as shown in FIG. 3A. The service introspection request corresponds to an initiation of provisioning model introspection as described herein. Accordingly, receiving the service introspection request includes receiving, at the provisioning model, an indication of one or more service specifications corresponding to a service qualification request (e.g., a service introspection and/or a service check).

At 314, the method 300 includes determining, by interpreting the provisioning model, service instance details based on the service specifications and outputting an instance result (e.g., to be received at 316 as shown in FIG. 3A). For example, the provisioning model interpreter is configured to perform one or more functions corresponding to provisioning a service for a customer based on the service specifications. These functions may include, but are not limited to, functions associated with provisioning a CFS request, calculating service instance details and decomposition based on parameters of the service specifications, etc. The instance result indicates whether the requested service can be provided in accordance with requested parameters, indicates default values associated with the parameters, indicates value range options for the parameters, and so on.

In some examples, at 326, the method 300 includes generating a provisioning plan in response to the service qualification request). In some examples, the provisioning plan is generated in response to step 324 as shown in FIG. 3A (e.g., to execute a dry run of the provisioning plan to facilitate narrowing of the instance result).

As described above with respect to FIGS. 3A and 3B, only certain functions/steps of the provisional model illustrated in FIG. 3B may be performed in response to/as a component of the provisioning model introspection performed in steps 310 through 328 of FIG. 3A. For example, introspection as described herein may include only one or more of steps 312 and 314. As illustrated in FIG. 3B, process flow corresponding to provisioning model introspection initiated at 310 of FIG. 3A may correspond only to the solid lines between respective steps.

Conversely, process flow corresponding to a provisioning request (e.g., an order request, such as a CFS order indicated selected options) may correspond to dashed lines between respective steps. For example, a provisioning plan may be run/executed in response to receiving an order request at 336. In response to receiving the order request at 336, the method 300 may proceed to determining service instance details at 314, generating the provisioning plan at 326, and running/executing the provisioning plan at 340.

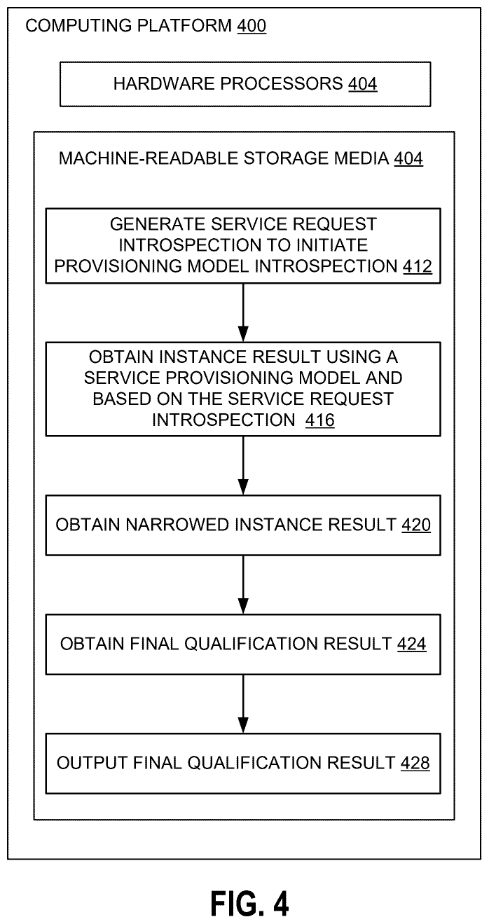

FIG. 4 illustrates a computing device or platform 400 that may be used to perform service qualification techniques according to the principles of the present disclosure. The computing device 400 may be, for example, a server computer, a controller, or any other similar computing device configured to process data. In the example implementation of FIG. 4, the computing device 400 includes a hardware processor 404 and machine-readable storage medium 408. In various examples, two or more of the computing devices 400 may be used to perform functions of the service qualification techniques, either individually or collectively.

The hardware processor 404 may be one or more central processing units (CPUs), semiconductor-based microprocessors, and/or other hardware devices suitable for retrieval and execution of instructions stored in the machine-readable storage medium 408. The hardware processor 408 may fetch, decode, and execute instructions to control processes or operations for anomaly detection. As an alternative or in addition to retrieving and executing instructions, the hardware processor 404 may include one or more electronic circuits that include electronic components for performing the functionality of one or more instructions, such as a field programmable gate array (FPGA), application specific integrated circuit (ASIC), or other electronic circuits.

The machine-readable storage medium 408 may be any electronic, magnetic, optical, or other physical storage device that contains or stores executable instructions. Thus, the machine-readable storage medium 408 may be, for example, Random Access Memory (RAM), non-volatile RAM (NVRAM), an Electrically Erasable Programmable Read-Only Memory (EEPROM), a storage device, an optical disc, and the like. In some examples, the machine-readable storage medium 408 may be a non-transitory storage medium, where the term “non-transitory” does not encompass transitory propagating signals. As described in detail below, the machine-readable storage medium 408 may be encoded with executable instructions as described below in more detail.

For example, the hardware processor 404 may execute instruction 412 to initiate provisioning model introspection by generating a service introspection request to query a provisioning model. For example, the instruction 412 may include generating the service introspection request based on service specifications determined for a service qualification request (and in response to receiving the service qualification request) and providing the service introspection request to the provisioning model.

The hardware processor 404 may execute instruction 416 to obtain one or more instance results using the provisioning model and based on the service specifications contained in the service introspection request. For example, to obtain the instance results, the provisioning model is configured to perform one or more functions corresponding to provisioning a service for a customer for each of the service specifications. The instance results indicate whether the requested service can be provided in accordance with requested parameters, indicate default values associated with the parameters, indicates value range options for the parameters, and so on. In various examples, instruction 416 may be executed by one of the hardware processors 404 different from one of the hardware processors 404 that executed the instruction 412 (e.g., in a different location).

The hardware processor 404 may execute instruction 420 to narrow, for each of the service specifications, the one or more instance results in accordance with more specific parameters/details associated with the service qualification request to obtain one or more narrowed instance results. Narrowing the instance results may include performing additional queries, investigations, or calculations, adding additional constraints associated with the service qualification request, querying external and/or partner systems, entities, or databases, prompting the service provisioning model to generate and execute a dry run of a provisioning plan, etc.

The hardware processor 404 may execute instruction 424 to obtain a final qualification result. Obtaining the final qualification result may include updating a qualification result based on the one or more narrowed instance results. The final qualification result indicates validation results for all service specifications corresponding to the service qualification request. Accordingly, the final qualification may include indications that one or more service requirements may be met and/or that one or more service requirements cannot be met.

The hardware processor 404 may execute instruction 428 to output the final qualification result. The final qualification result may be provided to the user. For example, the final qualification result is transmitted to a UE device for display on a user interface. In some examples, the final qualification result may be used to submit a CFS order. A system (e.g., the system 100, the system 200, etc.) may be configured to perform one or more actions or functions based on outputs of the hardware processor 404, such as outputs resulting from instruction 428 to output the final qualification result.

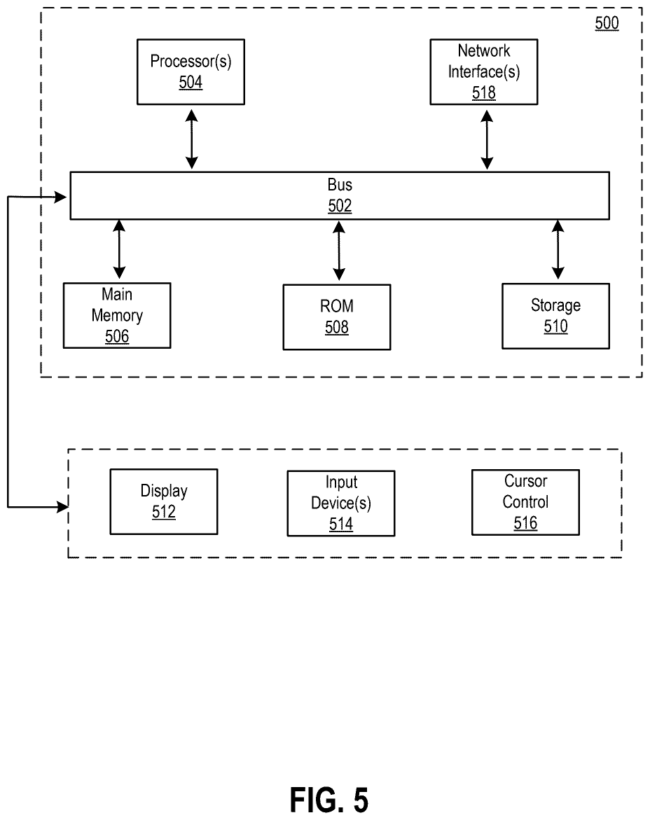

FIG. 5 depicts a block diagram of an example computer system 500 in which various examples of the disclosed technology described herein may be implemented. The computer system 500 includes a bus 502 or other communication mechanism for communicating information, one or more hardware processors 504 coupled with the bus 502 for processing information. The hardware processor(s) 504 may be, for example, one or more general purpose microprocessors.

The computer system 500 also includes a main memory 506, such as a random access memory (RAM), cache and/or other dynamic storage devices, coupled to the bus 502 for storing information and instructions to be executed by the processor 504. The main memory 506 also may be used for storing temporary variables or other intermediate information during execution of instructions to be executed by the processor 504. Such instructions, when stored in storage media accessible to the processor 504, render the computer system 500 into a special-purpose machine that is customized to perform the operations specified in the instructions.

The computer system 500 further includes a read only memory (ROM) 508 or other static storage device coupled to the bus 502 for storing static information and instructions for the processor 504. A storage device 510, such as a magnetic disk, optical disk, or USB thumb drive (Flash drive), etc., is provided and coupled to the bus 502 for storing information and instructions.

The computer system 500 may be coupled via the bus 502 to a display 512, such as a liquid crystal display (LCD) (or touch screen), for displaying information to a computer user. An input device 514, including alphanumeric and other keys, is coupled to the bus 502 for communicating information and command selections to the processor 504. Another type of user input device is cursor control 516, such as a mouse, a trackball, or cursor direction keys for communicating direction information and command selections to processor 504 and for controlling cursor movement on the display 512. In some examples, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs configure the computer system 500 to be a special-purpose machine. According to one example of the disclosed technology, the techniques herein are performed by the computer system 500 in response to the processor(s) 504 executing one or more sequences of one or more instructions contained in main memory 506. Such instructions may be read into the main memory 506 from another storage medium, such as the storage device 510. Execution of the sequences of instructions contained in the main memory 506 causes the processor(s) 504 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as the storage device 510. Volatile media includes dynamic memory, such as the main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise the bus 502. Transmission media can also take the form of acoustic or light waves, such as those generated during radio-wave and infra-red data communications.

The computer system 500 also includes a communication (e.g., network) interface 518 coupled to the bus 502. The network interface 518 provides a two-way data communication coupling to one or more network links that are connected to one or more local networks. For example, the network interface 518 may be an integrated services digital network (ISDN) card, cable modem, satellite modem, or a modem to provide a data communication connection to a corresponding type of telephone line. As another example, the network interface 518 may be a local area network (LAN) card to provide a data communication connection to a compatible LAN (or a WAN component in communication with a WAN). Wireless links may also be implemented. In any such implementation, the network interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through the network interface 518, which carry the digital data to and from the computer system 500, are example forms of transmission media.

The computer system 500 can send messages and receive data, including program code, through the network(s), network link, and the network interface 518. In the Internet example, a server might transmit a requested code for an application program through the Internet, the ISP, the local network and the network interface 518.

The received code may be executed by the processor 504 as it is received, and/or stored in the storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a module or circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit or module. In implementation, the various circuits or modules described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system configured to carry out the functionality described with respect thereto, such as the computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system for performing service qualification, the system comprising:
one or more processors; and
memory comprising instructions that, when executed, cause the one or more processors to
receive, via a user interface of a computing device, a service qualification request,
provide, to a provisioning model configured to provision a service for a customer, a service introspection request based on the service qualification request,
receive, from the provisioning model, one or more instance results indicating whether the service can be provided to the customer, and
generate and output, based on the one or more instance results, a qualification result indicating at least one of whether and when the service can be provided to the customer.

2. The system of claim 1, wherein the service introspection request includes receiving service specifications associated with the service qualification request, the memory further comprising instructions that, when executed, cause the one or more processors to narrow the one or more instance results.

3. The system of claim 2, the memory further comprising instructions that, when executed, cause the one or more processors to narrow the one or more instance results by:
determining respective service specifications for the service qualification request;
obtaining respective instance results based on each of the respective service specifications;
narrowing each of the respective instance results; and
generating and outputting the qualification result based on each of the respective instance results.

4. The system of claim 2, wherein narrowing the one or more instance results includes narrowing the one or more instance results based on constraints indicated by the service qualification request.

5. The system of claim 1, wherein narrowing the one or more instance results includes prompting the provisioning model to execute a plan to qualify the service.

6. The system of claim 1, wherein the service qualification request corresponds to a request for the service to be provided from a service provider.

7. The system of claim 1, wherein outputting the qualification result includes providing the qualification result to the user interface of the computing device.

8. The system of claim 1, wherein the one or more processors are configured to implement at least a portion of an application programming interface.

9. The system of claim 1, wherein the service qualification request corresponds to at least one of a service qualification query and a service check.

10. A system for performing service qualification, the system comprising:
a request generator configured to
receive, via a user interface of a computing device, a service qualification request,
provide, to a service controller configured to execute a provisioning model configured to provision a service for a customer, a service introspection request based on the service qualification request,
receive, from the service controller, one or more instance results indicating whether the service can be provided to the customer, and
generate and output, based on the one or more instance results, a qualification result indicating at least one of whether and when the service can be provided to the customer.

11. The system of claim 10, wherein the service controller is remotely located from the request generator.

12. The system of claim 10, further comprising the service controller.

13. The system of claim 10, wherein the service introspection request identifies service specifications associated with the service qualification request, and wherein the request generator is configured to narrow the one or more instance results based on the service specifications.

14. The system of claim 13, wherein the request generator is configured to narrow the one or more instance results by:
determining respective service specifications for the service qualification request;
obtaining respective instance results based on each of the respective service specifications;
narrowing each of the respective instance results; and
generating and outputting the qualification result based on each of the respective instance results.

15. The system of claim 13, wherein narrowing the one or more instance results includes at least one of (i) narrowing the one or more instance results based on constraints indicated by the service qualification request and (ii) prompting the provisioning model to execute a plan to qualify the service.

16. The system of claim 10, wherein outputting the qualification result includes providing the qualification result to the user interface of the computing device.

17. The system of claim 10, wherein the request generator is configured to implement at least a portion of an application programming interface.

18. The system of claim 10, wherein the service qualification request corresponds to at least one of a service qualification query and a service check.

19. A system for performing service qualification, the system comprising:
one or more processors; and
memory comprising instructions that, when executed, cause the one or more processors to
receive, via a user interface of a computing device, a service qualification request including at least a first service component having a first service specification and a second service component having a second service specification,
provide, to a provisioning model configured to provision a service for a customer, a first service introspection request based on the first service specification,
receive, from the provisioning model, a first instance result indicating whether the service can be provided to the customer in accordance with the first service specification,
provide, to the provisioning model, a second service introspection request based on the second service specification,
receive, from the provisioning model, a second instance result indicating whether the service can be provided to the customer in accordance with the second service specification,
generate and output, based on the first and second instance results, a qualification result indicating at least one of whether and when the service can be provided to the customer.

20. The system of claim 19, wherein outputting the qualification result includes providing the qualification result to the user interface of the computing device.
